(19) United States
(12) Patent Application Publication
(10) Pub. No.: US 2019/0050342 A1
(43) Pub. Date: Feb. 14, 2019

(54) SELECTIVE PAGE TRACKING FOR PROCESS CONTROLLER REDUNDANCY

(71) Applicant: HONEYWELL INTERNATIONAL INC., Morris Plains, NJ (US)

(72) Inventor: GARY DRAYTON, KING OF PRUSSIA, PA (US)

(21) Appl. No.: 15/671,585

(22) Filed: Aug. 8, 2017

(51) Int. Cl. G06F 12/1009; G06F 12/06; G06F 12/0813

(52) U.S. Cl. CPC G06F 12/1009; G06F 12/0638; G06F 2212/65; G06F 2212/205; G06F 12/0813

(57) ABSTRACT

A redundant process controller includes a primary and secondary process controller each with memory management unit (MMU) hardware and associated writeable memory including a tracked region having MMU pages for a control database. The primary and secondary process controller each have and an associated MMU tracker algorithm including an exception handler and process control algorithm. At a beginning of a first control algorithm cycle the primary MMU tracker algorithm sets all of primary MMU pages to read-only. The MMU tracker algorithm generates a page fault exception responsive to sensing a first primary MMU pages being written. During or upon an end of a control algorithm cycle, the primary processor controller transfers process data associated with only the first primary MMU page to the secondary process controller, wherein the process data is stored in a secondary MMU page in the control database in the secondary tracked region.

### FIELD

Disclosed embodiments relate to the updating of a secondary database of a redundant process controller in a fault-tolerant process control system, and more particularly, to a method and apparatus for tracking changes of predetermined process data of a primary database for subsequent updating of the secondary database.

### BACKGROUND

The failure of an industrial control system can lead to costly downtime. There is expense involved in restarting a process along with the actual production losses resulting from a failure. If the process is designed to operate without supervisory or service personnel, all of the components in the process control system generally need to be fault-tolerant which requires both hardware and software redundancy.

A fault-tolerant industrial process control system may employ 1:1 controller redundancy to synchronize the central processing unit (CPU) data in memory, where memory is maintained in an identical fashion in both a primary memory associated with a primary process controller and a secondary memory associated with a secondary process controller using an initial memory transfer followed by updates that are tracked changes to the primary memory image.

Process control industry customers have an expectation of high reliability when using fault-tolerant industrial process control systems that include hardware and software redundancy. To support this high reliability requirement, the process data received by a primary process controller must be tracked to a secondary controller so that the secondary controller can continue to provide process control in case the primary controller fails or is otherwise taken off line.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize it is not practical to track all the process data in a main writeable memory associated with the primary controller to the secondary controller, so that a mechanism is needed to identify all process data that has been changed in the most recent control cycle in the primary controller by control algorithms so this smaller set of process data can be tracked. Moreover, a problem for process control systems having redundant process controllers that have hardware and software redundancy which employ page tracking to identify data changed by control algorithms is the requirement for adding custom hardware to the process controller to ‘snoop’ on data writes by the processor (e.g., CPU) to its main writable memory. As known in the art and used herein, a ‘page’ (or a memory management unit (MMU) page) is the smallest memory unit in the main writable memory (e.g. 4 kbytes) that MMU hardware associated with a processor (e.g., a CPU) can individually handle for identifying a processor write operation that results in changed process data stored in the control database.

One of the significant problems with the known snooping approach for page tracking is that it does not allow for redundant execution of control algorithms on commercial hardware that lacks the custom designed hardware. Disclosed methods for identifying changed process data using page tracking by disclosed control algorithms are distinct from known methods of identifying change process data because disclosed methods feature new MMU tracker software that can operate on standard MMU hardware built into most modern CPUs today which are widely supported by standard operating systems. The MMU hardware utilized can be fully supported in virtual environments allowing for redundant execution in a virtual process controller pair for training, simulation, as well as cloud-based control of the process.

One disclosed embodiment comprises a redundant process controller that includes a primary and secondary process controller each with MMU hardware and associated writeable memory including a tracked region having MMU pages for a control database. The primary and secondary process controller each have an associated MMU tracker algorithm including an exception handler and process control algorithm. At a beginning of a first control algorithm cycle the primary MMU tracker algorithm sets all of primary MMU pages to read-only. The MMU tracker algorithm generates a page fault exception responsive to sensing a first primary MMU pages being written. During or upon an end of a control algorithm cycle, the primary process controller transfers process data associated with only the first primary MMU page to the secondary process controller, wherein the process data is stored in a secondary MMU page in the control database in the secondary tracked region.

### BRIEF DESCRIPTION OF THE DRAWINGS

FIG. 1 shows an example fault-tolerant industrial control system including a redundant process controller arrangement comprising a primary process controller and a parallel connected redundant secondary process controller both coupled to control processing equipment, where the respective process controllers both implement disclosed software-based page tracking for identifying changed process data, according to an example embodiment.

FIG. 2 shows an example illustration of an initial synchronization of all MMU pages in a writeable memory, according to an example embodiment.

FIG. 3 shows an example illustration of synchronization maintenance of written MMU pages at a synchronization point, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

As used herein an industrial process facility runs an industrial process involving a tangible material that disclosed embodiments apply. For example, oil and gas, chemical, beverage, pharmaceutical, pulp and paper manufacturing, petroleum processes, electrical, and water. An industrial process facility is distinct from a data processing system that only performs data manipulations.

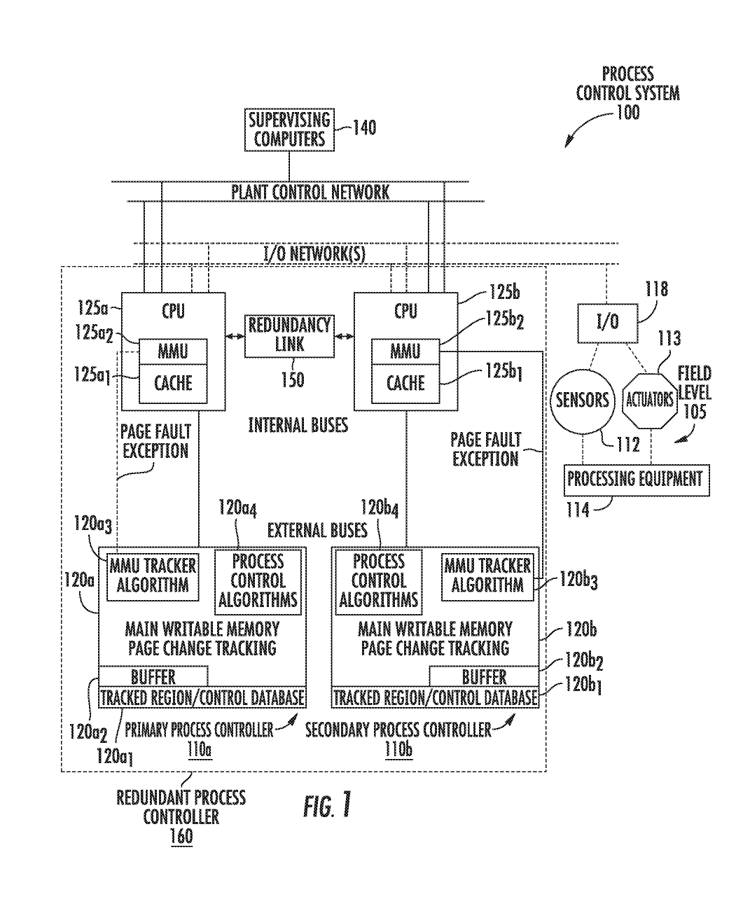

FIG. 1 shows an example fault-tolerant industrial control system 100 including a redundant process controller 160 comprising a primary process controller 110a and a parallel connected redundant secondary process controller 110b (both shown as CPU's) that are both coupled to control processing equipment 114, where the process controllers implement disclosed software-based page tracking for identifying changed process data for 1:1 controller redundancy, according to an example embodiment. The primary process controller 110a and secondary process controller 110b are both coupled by input/output modules (IOs) 118 to field devices comprising actuators 113 and sensors 112 that are coupled to the processing equipment 114 on a field level 105. ‘Redundant’ as used herein means functionally the same with respect to its process control functions which does allow for different device implementations or memory sizes for example.

In practice, the hardware tracking needs identical hardware and identical software in the primary process controller 110a and secondary process controller 110b as a backup because they are generally needed to be able to exchange roles to control the process, where the tracked memory addresses need to be identical in the primary and secondary memory in order for the database changes to be applied. The databases contain pointers to software functions in the main writable memories comprising primary writable memory 120a and secondary writable memory 120b. The IO networks shown couple various inputs and outputs to the primary process controller 110a and to the secondary process controller 110b including analog inputs (A/I), analog outputs (A/O), digital inputs (D/I), and digital outputs (D/O), these inputs and outputs being connected to various valves, pressure switches, pressure gauges, thermocouples, which are used to indicate the current information or status to enable controlling the process.

The primary process controller 110a includes a primary controller 125a, a primary writable memory 120a (e.g., RAM) including a primary MMU tracker algorithm 120a3, and a primary process control algorithms 120a4 for controlling the process through control of the processing equipment 114. The primary controller 125a has an associated cache memory 125a1 and MMU hardware 125a2. As known in the art, a MMU (sometimes called paged memory management unit (PMMU), handles all aspects of processor memory management, having all memory references passed through itself, primarily performing the translation of virtual memory addresses to physical addresses. Snooping is performed by the primary MMU hardware 125a2 to identify primary controller 125a writes done to MMU pages into the control database in the primary tracked region 120a1 and similarly by secondary MMU hardware 125a2.

The primary controller 125a is connected to the primary main writable memory 120a. The primary writable memory 120a includes the primary control database residing in MMU pages of a primary tracked memory region 120a1 and a primary page change tracking buffer 120a2 both shown by example in the same primary main writable memory 120a. The primary main writable memory 120a is optionally a non-volatile memory that can comprise RAM (static RAM (SRAM) for non-volatile memory).

The secondary process controller 110b analogous to the primary process controller 110a includes a secondary controller 125b, a secondary main writable memory 120b (e.g., RAM) including a secondary control cycle database (secondary control database) residing in a secondary tracked memory region 120b1 and a secondary page change tracking buffer 120b2 both shown by example in the same primary main writable memory 120a, as well as a secondary MMU tracker algorithm 120b3, and a secondary process control algorithms 120b4 for controlling the processing equipment 114 in the case of a detected fault in the primary process controller 110a. The secondary controller 125b has cache memory 125b1 and secondary MMU hardware 125b2. Snooping is performed by the MMU hardware 125b2 to identify primary controller 125a writes done to MMU pages into the control database 120b1. The secondary CPU 125b is connected to the secondary main writable memory 120b.

There is a redundancy link 150 between the primary controller 125a and the secondary controller 125b. The controllers 125a, 125b are both connected to a plant control network (PCN) including the supervisory computers 140 shown. The PCN generally includes operator stations and controllers. The IOs 118 shown refer to any I/O either local to the controller or connected via some communication medium.

All read and write accesses of the page change tracking buffers 120a2, 120b2 and the control databases in the tracked regions 120a1, 120b1 are controlled by the respective MMUs 125a2, 125b2. In the primary process controller 110a a list of changed MMU pages obtained by control of the MMU 125a2 and MMU tracker algorithm 120a3 are saved in the page change tracking buffer 120a2, so that only the changed (or ‘dirty’) MMU pages are subsequently transferred to the secondary process controller 110b over the redundancy link 150. In the secondary process controller 110b, redundancy data is copied to the secondary page change tracking buffer 120b2 area until it is processed at a cleanpoint (cleanpoint is a consistent set of changes to allow detecting lost packets to ensure cleanpoint) and only then is used to update the control database in the secondary tracked memory region 120b1.

During initial synchronization, at the beginning of a control algorithm cycle, all MMU pages in the control database in the tracked region 120a1 are set to read-only by the MMU tracker algorithm 120a3. As the process control algorithms 120a4 executes during each control cycle the primary controller writes the process data received from the IO networks into some of the MMU pages into the control database in the tracked region 120a1. The writing of a read only MMU page causes a page fault exception to be generated by the MMU 125a2 which is handled by the MMU tracker algorithm 120a3, where each MMU page written to as it was set to read only will cause an exception to be generated by the MMU 125a2. As shown in FIG. 1, the page fault exceptions are shown differently in the primary process controller 110a as compared to the secondary process controller 110b because for the primary controller when process data is written there is a page fault exception generated, while the secondary process controller 110b only generates page fault exceptions when it becomes the primary controller responsive to the primary process controller 110a being sensed to be down or otherwise taken off line.

The exception handler (part of MMU tracker control algorithm 120a3) receives from the MMU 125a2 the MMU pages numbers that have been changed (or made ‘dirty’), and the MMU tracker control algorithm 120a3 marks the changed MMU pages as changed (or ‘dirty’) by entering the changed/dirty MMU page numbers into the page change tracking buffer 120a2. A changed (or ‘dirty’) page is a page where the MMU hardware 125a2 has identified one or more write operations to the MMU page since the last time it was marked as being a “clean” page (no writes performed).

The setting of a changed or dirty page to read and write allows the process control algorithm 120a4 to read or write data preventing further exceptions for this MMU page, and then the exception handler will return allowing the write operation to this MMU page in the control database in the tracked region 120a1 to be retried. At end of each control algorithm cycle the page change tracking buffer 120a2 will thus have a list of MMU pages that have been written at least once.

Once the control algorithm cycle has ended, only the MMU pages marked as ‘dirty’ have their data transferred to the secondary process controller 110b over the redundancy link 150, and are then optionally marked by the secondary MMU hardware 125b2 as read-only pages. Setting the secondary to read only is an optional feature that can be used to detect improper secondary attempts to change the database. Transferring to the secondary process controller 110b and marking can be MMU page by MMU page, or applied to data in a plurality of dirty MMU pages (e.g. at the end of the control algorithm cycle). Repeated application of this process sequence allows software-based identification and tracking to enable transfer of only the process data in the MMU pages of the control database in tracked region 120a1 to the secondary process controller 110b that is changed on each control algorithm cycle.

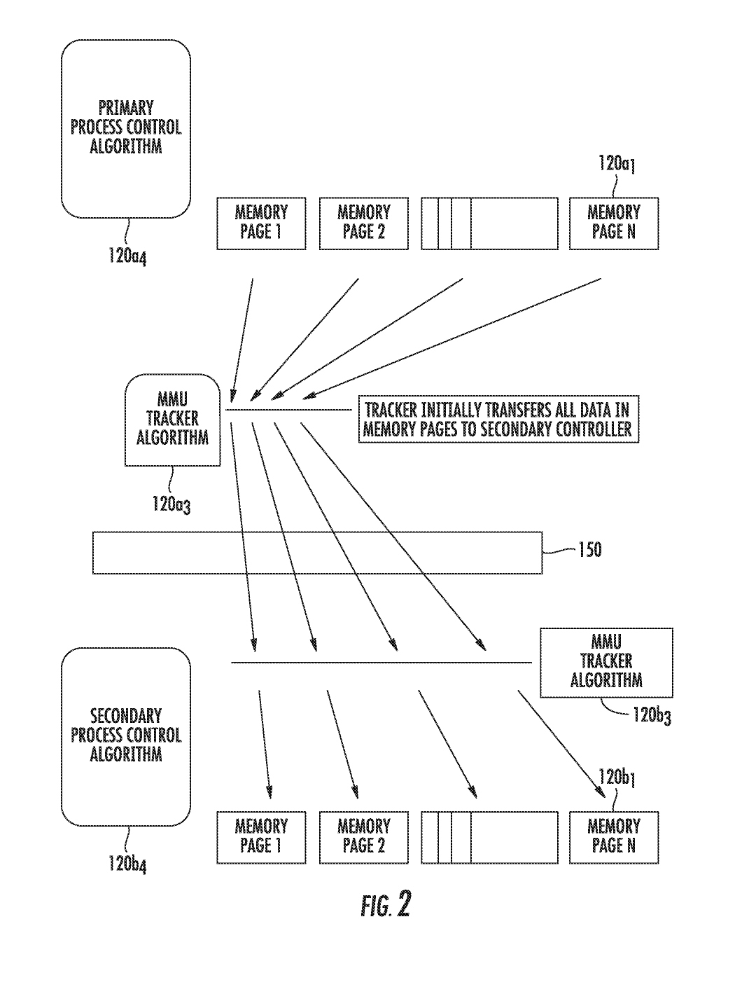

FIG. 2 shows an example illustration of an initial synchronization of all N MMU pages of a control database, according to an example embodiment. Initialization may occur upon starting the plant initially or after a plant shutdown so that the respective process controllers again become redundant, such as due to a hardware replacement that breaks controller synchronization. In this case, the MMU tracker algorithm 120a3 initially transfers data in all N MMU pages in the control database in the tracked region 120a1 over the redundancy link 150 to the control database to be stored in the tracked region 120b1 of the secondary controller 125b.

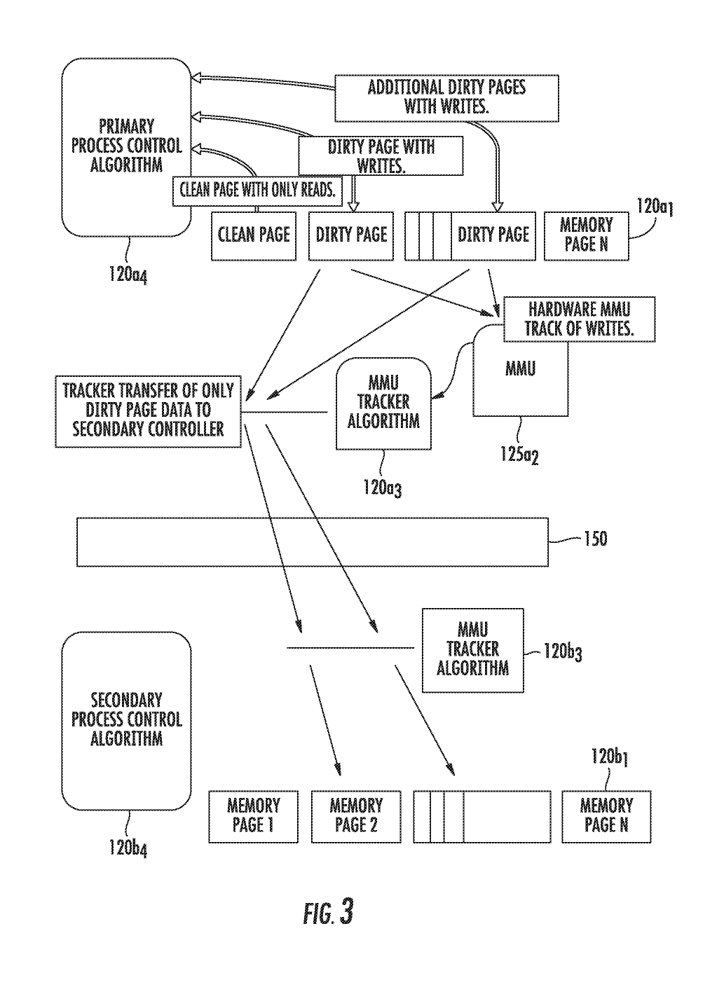

FIG. 3 shows an example illustration of synchronization maintenance of written MMU pages in the control database in the tracked region 120a1 at a synchronization point, according to an example embodiment. As described above at the beginning of the control algorithm cycle, all MMU pages in the control database in the tracked region 120a1 can be set to read only, and the writing of a read only MMU page causes a page fault exception to be generated by the MMU 125a2 which is handled by the MMU tracker algorithm 120a3, where each MMU page written to because it was set to read only will cause an exception to be generated by the MMU 125a2.

During the control algorithm cycle shown some of the MMU pages have had writes made and being written to are thus tracked by the MMU tracker algorithm 120a3 as being ‘dirty’, while some pages have not been written (shown as only being read) and thus remain clean MMU pages. At end of each control algorithm cycle the page change tracking buffer 120a2 will thus have a list of MMU pages that have been written to at least once. This information is used so that only the ‘dirty’ page data as shown are transferred over the redundancy link 150 to the control database in the tracked region 120b1 of the secondary controller 120b. This data transfer process as described above can be performed after every write during a control algorithm cycle, but it is generally more efficient to be performed as one data transfer at the end of every control algorithm cycle as multiple writes can occur during a control algorithm cycle.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. For example, disclosed methods can be used outside of process control systems, such as for any periodic application (having cycles) requiring redundant data. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

1. A method of maintaining process control data redundancy, comprising:
providing a fault-tolerant industrial process control system including processing equipment and field devices including a redundant process controller comprising a primary process controller comprising a primary processor having memory management unit (MMU) hardware and an associated primary writeable memory including a tracked region having a plurality of primary MMU pages for a control database, and a secondary process controller comprising a secondary processor having MMU hardware and an associated secondary writeable memory including a tracked region having a plurality of secondary MMU pages for said control database, said primary and secondary process controller connected by a redundancy link and each having an associated MMU tracker algorithm including an exception handler and a process control algorithm;
at a beginning of a first control algorithm cycle setting all of said primary MMU pages to read-only;
generating a page fault exception responsive to sensing at least a first of said primary MMU pages being written to;
during or upon an end of first control algorithm cycle, said primary process controller transferring process data associated with only said first primary MMU page to said secondary process controller, wherein said process data is stored in one of said secondary MMU pages in said control database in said secondary tracked region, and
for a new control algorithm cycle repeating said setting, sensing, tracking and said transferring.

2. The method of claim 1, wherein said MMU tracker algorithm associated with said primary process controller senses a page fault upon a change of each single one of said MMU pages.

3. The method of claim 1, wherein said primary process controller includes a primary page change tracking buffer, wherein said tracking comprises saving a page number of said first MMU page in said page change tracking buffer.

4. The method of claim 1, further comprising said exception handler setting all changed MMU pages including said first primary MMU page to read and write to allow said process control algorithm to read or write data preventing further exceptions for said first primary MMU page.

5. The method of claim 1, wherein said primary processor and said secondary processor both comprise a central processing unit (CPU) and said primary writeable memory and said secondary writeable memory both comprise random access memory (RAM).

6. The method of claim 1, wherein said transferring process data is only upon an end of a control algorithm cycle including at said end of said first control algorithm cycle.

7. A redundant process controller, comprising:
a primary process controller comprising a primary processor having memory management unit (MMU) hardware and an associated primary writeable memory including a tracked region having a plurality of primary MMU pages for a control database, and a secondary process controller comprising a secondary processor having MMU hardware and an associated secondary writeable memory including a tracked region having a plurality of secondary MMU pages for said control database, said primary and secondary process controller connected by a redundancy link and each having an associated MMU tracker algorithm including an exception handler and a process control algorithm:
at a beginning of a first control algorithm cycle said primary MMU tracker algorithm for setting all of said primary MMU pages to read-only;
said MMU tracker algorithm for generating a page fault exception responsive to sensing at least a first of said primary MMU pages being written to;
during or upon an end of said first control algorithm cycle ending, said primary process controller for transferring process data associated with only all said first primary MMU page to said secondary process controller, wherein said process data is stored in one of said secondary MMU pages in said control database in said secondary tracked region, and
for a new control algorithm cycle repeating said setting, sensing, tracking and said transferring.

8. The system of claim 7, wherein said MMU tracker algorithm associated with said primary process controller senses a page fault upon a change of each single one of said MMU pages.

9. The system of claim 7, wherein said primary process controller includes a primary page change tracking buffer, wherein said tracking is for saving a page number of said first MMU page in said page change tracking buffer.

10. The system of claim 7, further comprising said exception handler for setting all changed MMU pages including said first primary MMU page to read and write to allow said process control algorithm to read or write data preventing further exceptions for said first primary MMU page.

11. The system of claim 7, wherein said primary processor and said secondary processor both comprise a central processing unit (CPU) and said primary writeable memory and said secondary writeable memory both comprise random access memory (RAM).

12. The system of claim 7, wherein said transferring process data is only upon an end of a control algorithm cycle including at said end of said first control algorithm cycle.
